(19) United States
(12) Patent Application Publication
(10) Pub. No.: US 2011/0015987 A1
(43) Pub. Date: Jan. 20, 2011

(54) SYSTEMS AND METHODS FOR MARKETING TO MOBILE DEVICES

(75) Inventors: Dipanjan Chakraborty, Kolkata (IN); Koustuv Dasgupta, Gurgaon (IN); Dinesh Garg, Beawar (IN); Shivkumar Kalyanaraman, Vibhutipura (IN); Alwyn R. Lobo, Koramangala (IN); Sumit Mittal, Noida (IN); Deepak S. Padmanabhan, Udyogamandal (IN); Ramana V. Polavarapu, Bellandur (IN); Lakshmish M. Ramaswamy, Athens, GA (US); Karthik Visweswariah, J.P. Nager 6th Phase (IN)

Correspondence Address: FREDERICK W. GIBB, III;Gibb Intellectual Property Law Firm, LLC, 844 West Street, SUITE 100, ANNAPOLIS, MD, 21401, US

(73) Assignee: International Business Machines Corporation, Armonk, NY (US)

(21) Appl. No.: 12/505,734

(22) Filed: Jul. 20, 2009

(51) Int. Cl. G06Q 30/00; H04W 4/00

(52) U.S. Cl. 705/14.39; 705/14.64; 705/14.61; 705/14.1; 705/14.55; 705/14.58; 705/14.53; 705/14.52; 705/14.48; 705/14.71; 455/466

(57) ABSTRACT

Systems and methods of marketing to mobile devices are provided. Other methods, apparatus, and computer readable media are also provided.

### BACKGROUND

Micromarketing is the practice of tailoring products, brands, and promotions to meet the needs and wants of microsegments within a market. Micromarketing channels include Internet technology, such as email and any form of advertising on the World Wide Web (including targeted ads), as well as mobile technology including SMS and any form of advertising on mobile phones.

A major problem in mobile advertising is that advertising messages are viewed as spam, and clutter up SMS or MMS inboxes. Because the advertising messages also consume valuable memory, they cause users to delete or manage these messages (wasting their precious time) or cause users to subscribe to do-not-call or do-not-sms lists. According to Wireless Watch, Vol. 6, No 29, Oct. 15, 2008, half of those yet to deploy a mobile marketing campaign are concerned that their customers will view the text messages as spam.

Pull-based or subscription-based methods for mobile ads also present problems. They still result in cluttered SMS or MMS in-boxes, causing users to delete or manage the messages, and there is still the spam perception.

If it were possible to remove the spam perception of mobile marketing, and increase user-control, this would significantly increase the likelihood of users adopting and responding to mobile marketing of various kinds (push/pull, location/context aware, etc).

### SUMMARY

Various embodiments provide systems and methods for marketing to mobile devices (such as mobile phones and PDAs) where a marketing system is managed by a telecom operator (telco) or independent service provider.

Some aspects provide a method for marketing to mobile devices of users, the method comprising receiving marketing messages from vendors along with information identifying the locations of the vendors and information indicating when the respective marketing messages expire; starting a USSD session with a user's mobile device in response to a request from the user; providing a menu to the user's mobile device in the USSD session with which the user can view marketing messages; and automatically flushing expired marketing messages; wherein marketing messages are stored and managed by a telecom provider instead of being sent to a mobile device's in-box.

Other aspects provide a system for marketing to mobile devices of users, in which a user of a mobile device can pull advertisements of advertisers on-demand from a telecom provider, the system comprising a pull mechanism, using which a user of a mobile device can express an interest in fetching an advertisement, the pull mechanism including telecom equipment configured to receive a communication from the mobile device; a mechanism using which a user can indicate product categories of interest, using the mobile device; a system configured to record information relating to purchases by the user; and an advertisement matching system configured to match advertisements to customers based on a plurality of real time attributes including at least one real time attribute selected from the group consisting of location of the user and product categories of interest to the user, as well as based on parameters of the telecom provider and parameters of the advertisers.

Still other aspects provide a method of marketing to mobile devices of users from a telecom operator, the method comprising receiving a telecom contact from a user of a mobile device, the contact indicating an interest in fetching an advertisement, and receiving product categories of interest to the user; matching a user with at least one advertisement based on at least some of product categories of interest to the user and a location of interest to the user; selecting at least one advertisement relevant to the user and based on at least one metric of interest to the advertiser as well based on at least one metric of interest to the telecom operator; and delivering at least one advertisement to the mobile device. Other methods and apparatus are also provided.

### BRIEF DESCRIPTION OF THE VIEWS OF THE DRAWINGS

FIG. 1 is a block diagram of an exemplary embodiment of a system for marketing to mobile devices.

FIG. 2 is a front view of an exemplary embodiment of a mobile device including a user interface.

FIG. 3 is a front view of an exemplary embodiment of a mobile device user interface at a stage later than that shown in FIG. 2.

FIG. 4 is a block diagram of a system for marketing to mobile devices in accordance with alternative exemplary embodiments.

FIG. 5 is a flowchart of an exemplary embodiment of a feedback tracking mechanism.

FIG. 6 is a flowchart of an exemplary embodiment of an alternative feedback tracking mechanism.

FIG. 7 is a diagrammatical flowchart of an exemplary embodiment of a system that makes use of real time attributes.

FIG. 8 is a functional block diagram of subcomponents of a mobile micromarketing system shown in FIG. 4.

FIG. 9 is a tree diagram of an exemplary embodiment of a menu hierarchy of a catalog of product categories.

FIG. 10 is a block diagram of an exemplary embodiment of a system architecture.

### DETAILED DESCRIPTION

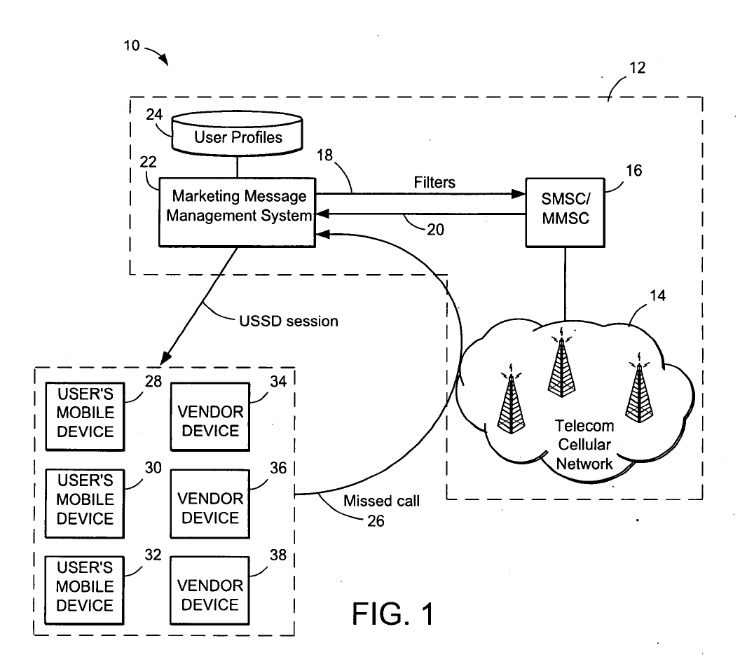

FIG. 1 is a block diagram of an exemplary system 10 for marketing to mobile devices. In the system of FIG. 1, coupons and marketing communications from qualified telecom partners (or vendors chosen by users)are managed by the telecom provider or operator 12 itself (without cluttering SMS or MMS in-boxes). The telecom provider or telco 12 has a telecom cellular network 14. The network 14 includes cell towers which may be owned or leased (or a combination of both) by the provider 12 and telecom equipment capable of sending, receiving, and connecting calls and providing other typical mobile phone services such as caller ID, call waiting, call forwarding, call reject, and data services. The provider may also reach customers over other providers' networks. The provider 12 has a message center such as a short message service center (SMSC) or multimedia messaging service center (MMSC) 16 which receives and delivers SMS messages. The provider 12 also has a marketing message management system or coupon locker 22 which will be described in greater detail below. The system 22 includes or selectively accesses a database of user profiles 24 that are included in a storage device.

In the illustrated embodiment, for example, marketing messages such as coupons from vendors (e.g., retailers, manufacturers, restaurants, malls, service providers, etc.) that are partners of the telecom provider 12 are made available to a user. In some embodiment, these marketing messages are made available from time to time or periodically, such as weekly. In some embodiments, only coupons in the local area (e.g., in nearby zip codes, only in the user's home zip code, or within a radius, such as a 5 mile radius of the user's home, present location, or of the user's residential address or billing address zip code) will be made available. A user can select a zip code (or specify a locality keyword) and get coupons for that zip code or locality keyword, organized by the user's customized browsing preferences.

In some embodiments, all users are automatically signed on to receive marketing messages, and there is no explicit sign-on process.

In the illustrated embodiment, invalid and/or expired coupons are automatically flushed out. This can be done, for example, by identifying (detecting) strings such as “valid upto” or “expires on” provided in the coupons.

When the user is interested in coupons, he or she gives a missed call 26 from his or her mobile device or phone 28, 30, 32 etc. to a published or advertised (e.g., well-known) phone number. The missed call is of low cost to the user. Alternatively, in some embodiments, when the user is interested in coupons, he or she sends a USSD short code from his or her mobile device 28, 30, 32, etc. to the marketing message management system 22 via the network 14. This is Thus, this is an opt-in approach.

In some embodiments, the system 22 uses a missed call 26 as a trigger to start a unstructured supplementary service data (USSD) session with the user and display a personalized menu for the user to browse coupons. Unstructured supplementary service data is a capability of all GSM phones. Unstructured supplementary service data is a simple text exchange service allowing the display of menus on a mobile phone and enabling users to interact with these menus. USSD Phase 1 only supports mobile initiated operations (pull operations), but USSD Phase 2 supports network-initiated operations (both pull and push operations). The missed call or SMS is trapped via a telecom interface (like Parlay-X or SMSC) and the missed call triggers a USSD session offering a personalized coupon browsing menu. Other ways to trigger coupons could be employed in other embodiments.

Users can “clip” coupons of interest. In some embodiments, a user can put clipped coupons of interest in a separate folder and later use them in-store or in a remote interaction (via phone or internet) with the coupon-issuing vendor.

In some embodiments, if a vendor or retailer is not a telecom partner, a user can forward 20 an SMS ad or coupon received from a vendor entity to the system 22 using the same phone number (or short-code) via the network 14, and SMSC or MMSC 16. The provider 12 traps future SMS messages from that vendor and the system 22 then manages those messages.

In some embodiments, a user of a mobile device 28, 30, or 32 can forward coupons to friends, and this information is automatically trapped and managed by the system 22 (if the friend uses the same operator 12), with a notification SMS being sent to the friend's mobile device.

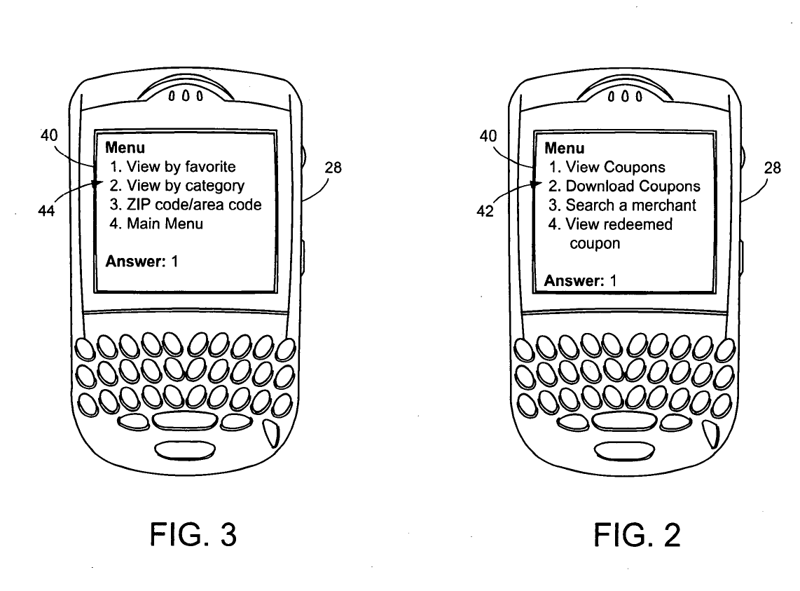

FIG. 2 shows a mobile device 28 including a user interface 40 that is displayed to a user in response to the missed call or short message. In the illustrated embodiment, menu choices for a main menu 42, shown on the interface 40, include items such as “view coupons,” “download coupons,” “search a merchant,” “view redeemed coupon,” or other similar or additional options. A user can select an option by operating the mobile device 28, such as by keying in a character or numeral associated with a menu choice.

In some embodiments, a user can select “favorite” retailers or categories while viewing merchants (menu item 3 in FIG. 2) or coupons (menu item 1 in FIG. 2) and customize the subsequent dynamic menu displayed.

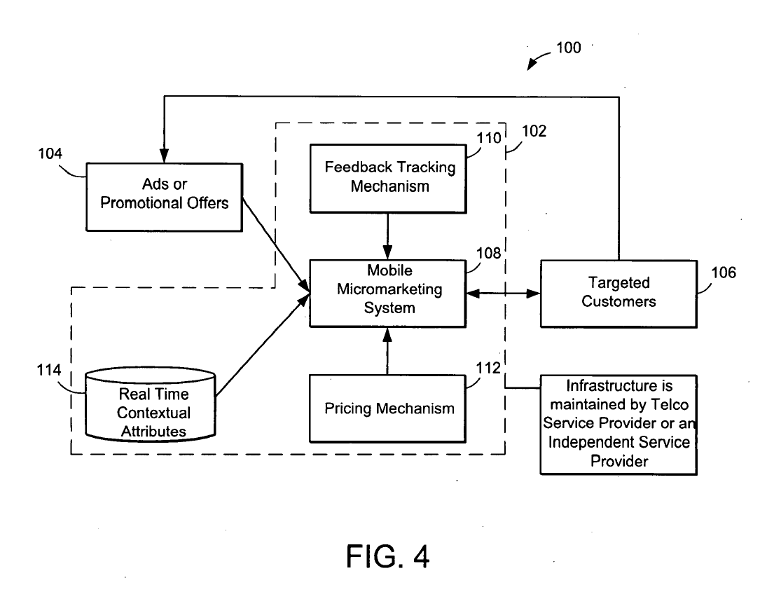

FIG. 3 shows the mobile device 28 after menu choice 1 was selected from the menu 42 of FIG. 2. In the illustrated embodiment, menu choices for a coupon menu 44, shown on the interface 40, include items such as “view by favorite,” “view by category,” “zip code” (or area code), and (return to) “main menu.” Similar or additional menu options are also possible.

In the illustrated embodiment, the user can select a zip code (or specify a locality keyword) after selecting menu option 3 in FIG. 3 and get coupons for that zip code/locality keyword, e.g., organized by their customized browsing preferences. Preferred partners specify store locations or zip codes in messages, and the location information is used to filter messages such that only coupons for the relevant zip codes for the user (home neighborhood zip codes or current neighborhood zip codes) are displayed.

A vendor or retailer can apply a coupon such as by sending a coupon number to the system 22 from a vendor device 34 such as a vendor mobile device 34, 36, 38, etc. via USSD or SMS, or from a point of sale terminal using a POS application, in some embodiments. In other embodiments, a vendor can communicate with the system 22 in additional or other ways to apply a coupon, such as through a telephone call, or from a computer or point of sale terminal via the Internet, satellite, telephone land line, or other connection. In the illustrated embodiment, the coupon encashment is reflected immediately in the user's account. More particularly, the coupon encashment is thus reflected immediately in the system 22, when the retailer applies a coupon by sending the coupon number or other identifying indicia to the system 22 via USSD, SMS, or a POS-application.

Thus, systems and methods for managing marketing messages and coupons in a telecommunications network have been provided where marketing messages from preferred partners or user-indicated sources are filtered and managed by a telecom provider rather than sent as (and perceived as) spam into SMS or MMS mobile phone in-boxes. Conventional advertisements delivered to a phone via SMS, MMS, or email clutter a user's inbox and are perceived as spam. On the other hand, in some of the embodiments provided here, including embodiments described in connection with FIGS. 1-3, pull based (anti-spam), user driven, context aware delivery systems and methods are provided. There is no need to transmit data to a phone or other mobile device unless a user is interested in looking at the data, resulting in increased spectral efficiency. Applications resident on a phone assume certain minimum requirements of the phone hardware and this makes them hard to deploy widely. In various embodiments disclosed here, including some of the embodiments described in connection with FIGS. 1-3, coupon management is performed on a server and does not require any application on a phone or other type of mobile device. In various embodiments, a system can integrate seamlessly with service providers' service delivery platforms to deliver coupons using existing mobile applications and channels. In some embodiments, the recommendations of coupons are based on business analytics and patterns observed from past usage, transaction history, lifestyle segments and preferences.

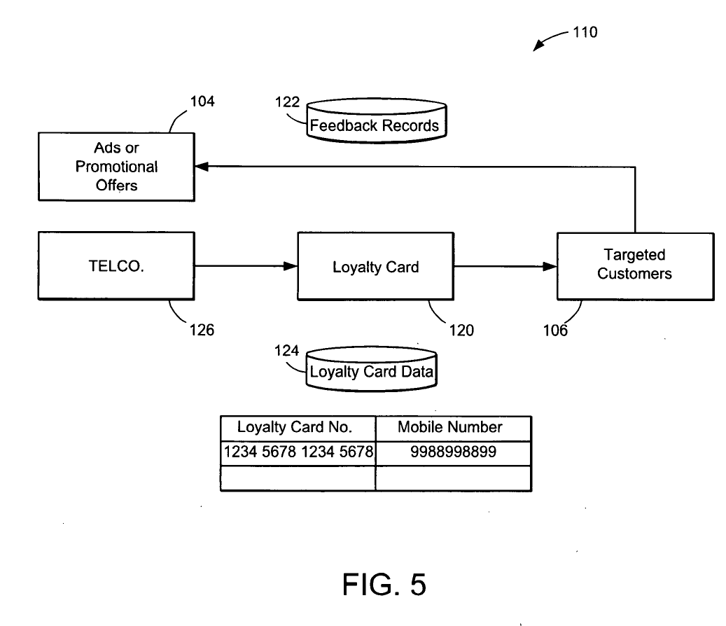

FIG. 4 is a block diagram of a system 100 for marketing to mobile devices in accordance with alternate exemplary embodiments. The system 100 includes a system or infrastructure 102 maintained by a telephone company service provider (telco) or an independent service provider. The system 102 includes a mobile micro marketing system 108 for selectively delivering ads supplied by vendors 104 to targeted customers 106 in a manner that will be described below. The system 102 further includes a feedback tracking mechanism 110, used by the mobile micro marketing system 108, to track customer purchase activity resulting from ads.

The system 102 further includes a pricing mechanism 112, used by the mobile micro marketing system 108 to set the costs for advertising campaigns. In some embodiments, the pricing mechanism 112 uses a pay per impression approach. In other embodiments, the pricing mechanism 112 uses a pay per transaction approach. In a pay per transaction approach, the amount to be charged, in some embodiments, is decided based upon auction rules. In other embodiments, the amount to be charged in a pay per transaction approach is based upon some other heuristic.

In some embodiments, the mobile micro marketing system 108 makes use of real time contextual attributes 114, that will be described below.

The feedback tracking mechanism 110 can be any system which enables measuring the transactions triggered due to the ads or promotional offers sent by the system 102. In some embodiments, customers are issued loyalty cards which need to be presented at checkout in order for a customer to receive a discount indicated in an ad. The cards are scanned at checkout, or a number from the card is input into an input device or point of sale terminal which communicates with the system 108, to provide feedback tracking. Thus, the input device or point of sale terminal can define part of the feedback tracking mechanism.

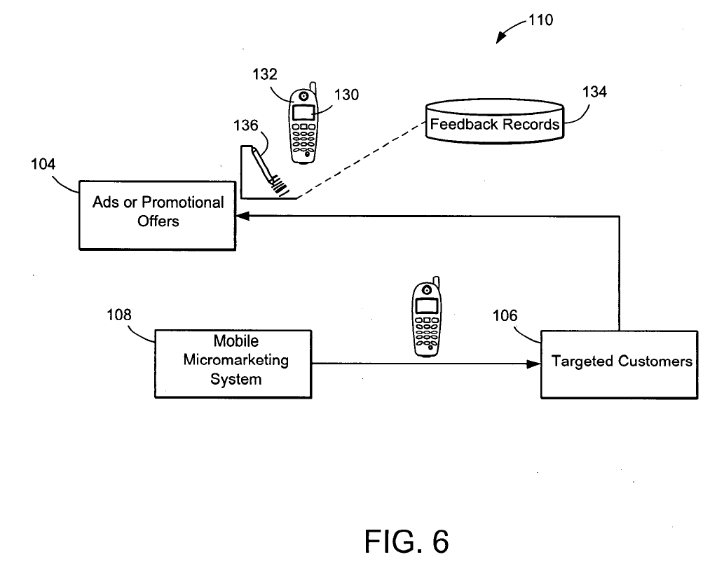

FIG. 5 is a flowchart illustrating a method of feedback tracking using a loyalty card or cards 120. FIG. 5 shows an embodiment of a feedback tracking mechanism 110 which includes a data storage device defining a database 122 including feedback records, and a data storage device defining a database 124 including loyalty card data. In operation, a mobile user uses a loyalty card 120 while shopping at any retail outlet or vendor which is part of the telco-retail network. In some embodiments, the users get special discounts from the vendors on their purchases. In some embodiments, for every purchase, users get reward points in their loyalty account which can be redeemed for rewards. Any of various rewards can be employed. In the illustrated embodiment, loyalty points can be redeemed for free talk time on the telco that operates the system 102. In some embodiments, the cards 120 are offered by a telecom provider 126. In other embodiments, the cards 120 are jointly offered by a bank and telecom provider and the card can also be used as a credit card or debit card.

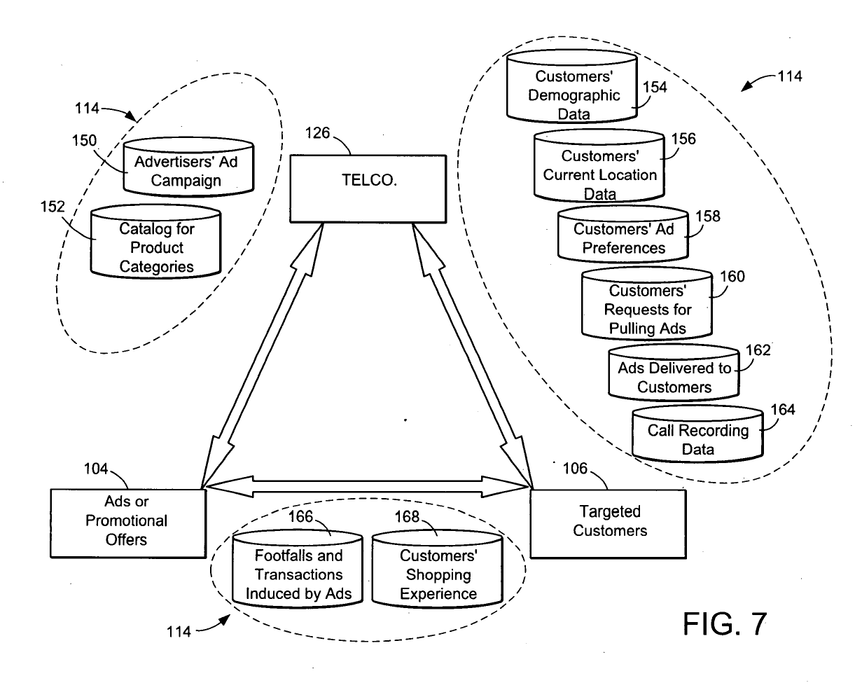

In some embodiments, illustrated in FIG. 6, a bar code is sent to a customer's mobile phone 132 and displayed on the phone, and that bar code is scanned at checkout. More particularly, FIG. 6 is a flowchart illustrating a method of feedback tracking using a bar code 130 displayed on a mobile device 132 of a user. FIG. 6 shows an embodiment of a feedback tracking mechanism 110 which includes a data storage device defining a database 134 including feedback records. In operation, the system 108 delivers an ad, or promotional offer or coupon to a mobile device of a targeted customer (mobile user) 106. The mobile user provides the bar code 130 to a vendor while shopping at any retail outlet or vendor which is part of the telco-retail network. The vendor scans the bar code 130 using a scanning device 136. The scanning device 136 may be part of or associated with a vendor's point of sale system that is able to selectively communicate with the system 102. The transaction is recorded in the feedback records 134.

In various feedback tracking embodiments, some incentive (e.g. talk time) is provided to customers if they report their transactions.

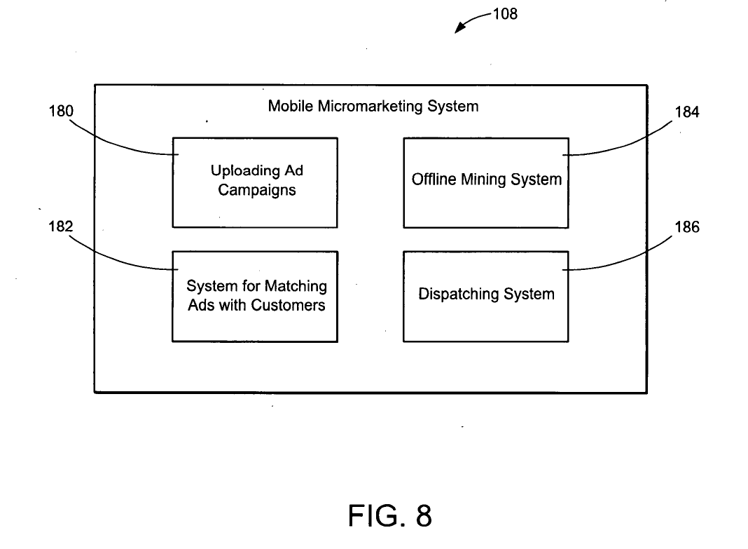

FIG. 7 illustrates real time contextual attributes 114 that the system 108 of the telecom provider 126 can take into account, in some embodiments. These attributes 114 can be stored in a memory device or in multiple memory devices at the telecom provider 126 or controlled by the telecom provider 126. The real time attributes can include one or more of advertiser's ad campaigns 150, catalogs 152 for product categories, customers' demographic data 154, customers' current location data 156, customers' ad preferences 158, customers' requests for pulling ads 160, ads delivered to customers 162, call recording data 164, footfalls and transactions induced by ads 166, and customers' shopping experiences 168. Real time contextual attributes are described in greater detail in a paper entitled “CAESAR: A Context-Aware, Social Recommender System for Low-End Mobile Devices” by Lakshmish Ramaswamy et al., International Conference on Mobile Systems, Services and Middleware, Taipei, Taiwan, May 18-20, 2009, which is incorporated herein by reference.

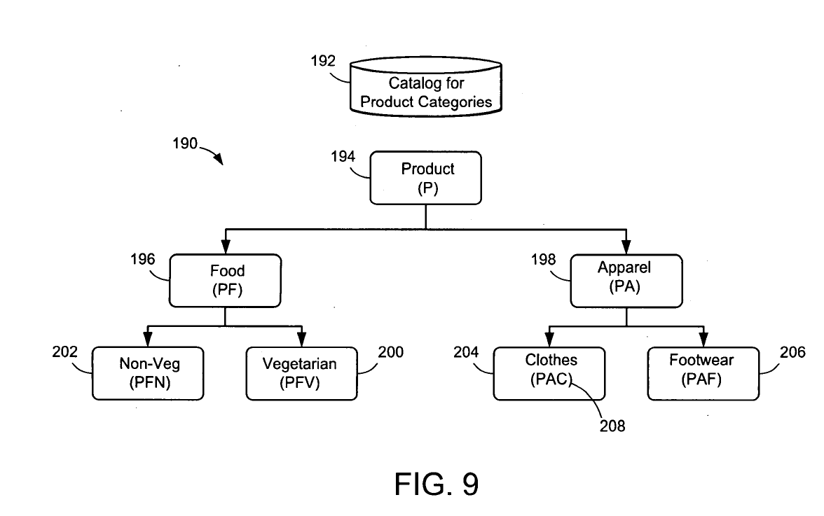

FIG. 8 is a functional block diagram showing subcomponents of the mobile micromarketing system 108 shown in FIG. 4. In the embodiment shown in FIG. 8, the mobile micromarketing system 108 includes a system 180 using which vendors can upload ad campaigns, a system 182 for matching ads with customers, and a system 186 for dispatching ads to customers. An online mining system 184 may also be included.

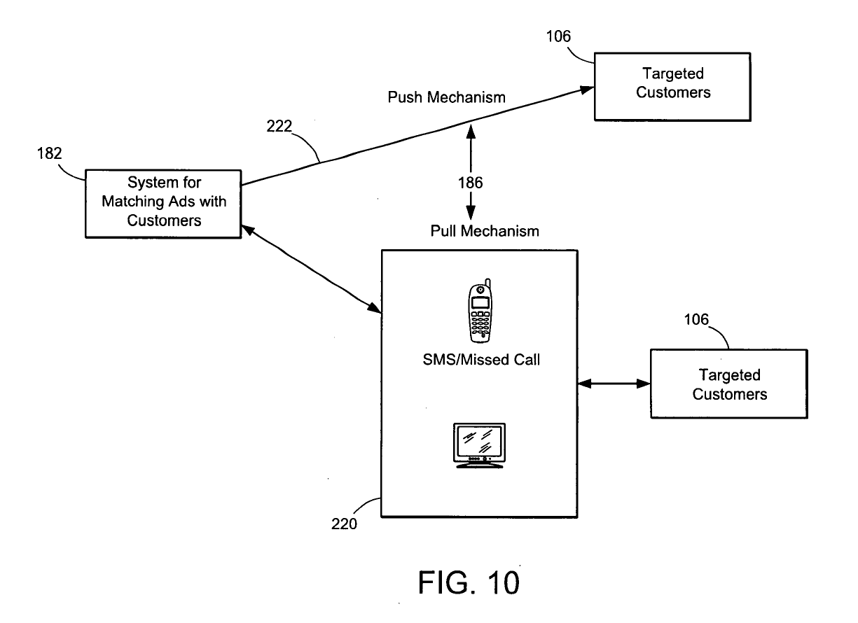

FIG. 9 is a tree diagram of an exemplary embodiment of a menu hierarchy 190 or list of a catalog 192 of product categories. The catalog 192 is maintained by the system 108. The catalog 192 is also maintained at the mobile devices of the users 106. The catalog 192 shown in FIG. 9 is an example of a menu that starts with a selection of type of product 194, whether food 196 or apparel 198. If food 196, there is a choice of type of food, whether vegetarian 200 or non-vegetarian 202. If apparel 198, there is a choice of type of apparel, whether clothes 204 or footwear 206. This catalog is provided by way of example only. Other hierarchies and options could also be provided. In some embodiments, different short codes 208 are displayed for different menu choices such as PAC for clothes 204. In some embodiments, when a user sends a request to pull ads, the user specifies the product category, e.g., using a code 208.

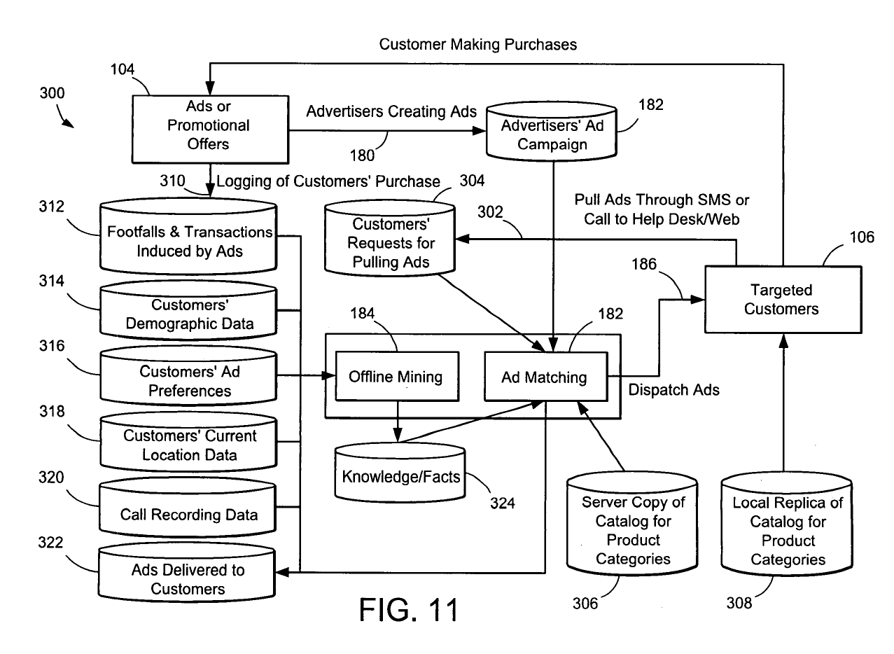

FIG. 10 illustrates operation of the dispatching mechanism 186 of FIG. 8. In the illustrated embodiment, the dispatching mechanism 186 includes a pull mechanism 220 using which customers 106 can request ads. In some embodiments, a customer 106 sends an SMS or missed call to the system 102 to pull an ad. The system for matching ads with customers (ad matching system) 182 sends an appropriate ad to the customer. In some embodiments, the dispatching mechanism 186 further includes a push mechanism 222 in which the ad matching system 182 sends ads to targeted customers.

With regard to the ad matching system 182, the inventors have recognized that the objectives of different stakeholders are different. The telecom provider wants to maximize the revenue; advertisers or vendors want to maximize the number of transactions per unit of money spent; and users want maximum relevance of ads. For users, the number of ads to be sent is limited by screen size. A successful system must address all these needs at the same time. In some embodiments, the ad matching system 182 can operate using one or both of the following:
(a) For any pull request, find out the set of ads which are relevant based on some relevance score (i.e. geographic proximity between the current location of the mobile and advertiser+textual similarity; and
(b) Rank the ads in decreasing order of products of bids and corresponding relevance and then pick the top m ads, where m is a predetermined number.

In some embodiments, the ad matching system 182 uses at least some of the principles described in the paper entitled “CAESAR: A Context-Aware, Social Recommender System for Low-End Mobile Devices” by Lakshmish Ramaswamy et al., International Conference on Mobile Systems, Services and Middleware, Taipei, Taiwan, May 18-20, 2009, incorporated herein by reference.

The following table provides an example of the type of data that can be stored in the feedback records 122 or 134 of FIG. 5 or 6.

TABLE 1

| | Ads | | | | | | |
|---|---|---|---|---|---|---|---|
| | Request | | | | | | Amount |
| | Arrival | Mobile's | | | | Purchase | Charged |
| Mobile | Date & | Location | Purchase | | Product | Date & | from |
| Number | Time | ZIP | Made | Vendor ID | Purchased | Time | Advertiser |
| 9343866653 | Dec 12, | 560071 | Y | Pai | TV | Dec 12, | 80 |
| | 2007, | | | Electronics | | 2007 | |
| | 9AM | | | | | 10 AM | |
| 9945726462 | Dec 15, | 560001 | N | Big Bazar | Flour | Dec 15, | 3 |
| | 2007, 5 | | | | | 2007 | |
| | PM | | | | | 6 PM | |

In various embodiments, the mining system 184 of FIG. 8 mines information from this data. Examples of data that could be mined include customer neutral, vendor neutral trends. For example, the percentage of the coupons for P product category which have more than a D % of discount that result into a purchase. Customer neutral, vendor specific trends can also be mined. An example is the percentage of the coupons for P product category from vendor V that result in a purchase. Customer specific, vendor neutral trends can also be mined. An example is the percentage of times a person A makes a purchase from product category P when he/she pulls a coupon on Sunday (deep sell). Customer specific and vendor neutral trends can also be mined such as to determine that person A rarely pulls the ads for the product category Q which are generally pulled by customers who pull category P (cross sell). Customer specific, vendor specific trends can be mined. An example is the percentage of purchases person B makes from Zip code Z. Social network related trends can also be mined. An example is the percentage of friends of Person C who make purchases at least Y % of the times they pull coupons. Other data mining is possible.

FIG. 11 is a block diagram that illustrates the overall architecture of a system 300 in accordance with various embodiments. Advertisers create 180 advertisers' ad campaigns 182 that are stored in the system 300. Customers 106 can pull ads 302 such as by sending an SMS request to a predetermined number, using the World Wide Web, sending a call, or sending a missed call. Customers' request for pulling ads can be stored in a memory 304. An ad matching system 182 dispatches 186 selected ads to targeted customers 106 using a server copy 306 of a catalog of product categories. Local replicas 308 are available on mobile devices of targeted customers 106. Customers' purchases are logged 310 for use in a feedback mechanism and for data mining.

The system 300 includes a memory device or memory devices defining databases or otherwise arranged to store data for at least some of the following: customers' requests for pulling ads 304, footfalls and transactions induced by ads 312, customers' demographic data 314, customers' ad preferences 316, customers' current location data 318, call recording data 320, and ads delivered to customers 322, any of which can be used by the offline data mining system 184 to define knowledge or facts 324 that can be used by the ad matching system 182.

To better enable one of ordinary skill in the art to make and use the invention, one possible end to end implementation will now be provided. It is to be understood that this specific embodiment is provided by way of example only and that other embodiments are possible.

First, a telecom provider issues loyalty cards and maintains records including records of which loyalty card number is associated with which mobile phone number. The mobile users can use the loyalty cards while shopping at any retail outlet which is part of the telco-retail network. The users get special discounts from the retailers on their purchases. For respective purchases, user get some reward points accumulated in their account which can be redeemed against free talk time. The card can be jointly offered by a bank and telecom provider such that the card can be used as a credit card also.

Next, a product category catalog is defined and advertisers specify a price per impression for each ad campaign. The following table provides an example of how different vendors can set different budgets for ad campaigns.

TABLE 2

| | | | | Willingness to | |
|---|---|---|---|---|---|
| Advertiser' | | Product | Description of the Deal | Pay Per | Daily |
| ID | ZIP | Category | (50 Char Max) | Impression | Budget |
| Pai | 560071 | PHT | Buy Flat Screen 26″ TV and get gift | INR 0.1 | INR |
| Electronics | | | voucher of 500 Rs. | | 1000 |
| Big Bazar | 560023 | PFG | Shop apparel, cosmetics or | INR 0.01 | INR |
| | | | groceries for Rs. 500 or more, get | | 10000 |
| | | | discount of 5% beyond sale prices | | |
| | | | in-store! | | |
| PVR | 560031 | PEC | Buy 1 ticket for movie X and get | INR 0.05 | INR |
| | | | 50% discount on the other ticket for | | 5000 |
| | | | the movie X | | |

A telecom provider creates and maintains the product category catalog. An advertiser can maintain a local replica of this catalog either on a computer or on a mobile phone. The catalog can be refreshed periodically, such as once per day. The advertisers use the local replica to pick a product category while creating an ad campaign. An advertiser can create an ad campaign, for example, by filling in a form on the Internet (e.g., using a Web Browser) or using a mobile phone. This form will contain the fields shown in the table above. The telecom provider uses this ad campaign database in real time to match ads dispatched to the incoming ad requests.

A system has been proposed that benefits all stakeholders. In some embodiments, end users get a spot discount and/or a reward point or points (i.e., redeemable for free talk time). Advertisers benefit from having higher footfalls. In some embodiments, advertisers can track how many footfalls each ad campaign brought and the price paid per footfall for each ad campaign. An advertiser can create multiple ad campaigns and divide a daily budget across these campaigns and also adjust the PPI values for these ad campaigns so as to maximize overall utility for the advertiser. The telecom provider is earning money by matching demand and supply and paying some fraction of this revenue in order to give incentives to the users to fuel this business model by creating demand for the ads.

Various alternative embodiments provide an auction house approach which will now be described, by way of example.

(a) For a request for ads, such as a 2222 request (or other predetermined code), one or both of the following are performed: (i) If a user has not specified product categories, find product categories using the static profile of the user. (ii) Find product categories of the user's friend or friends (determine friends using from call data) from the friends' static records. Use (a)(i) and (a)(ii) and find a set of product categories which the user might be most interested in.

(b) For each selected product category, find ads which satisfy some basic constraints such as the vendor being located close enough to the user's current location. For each of these ads, (i) compute the probability of the user buying products from this vendor by looking at various trends or facts related to this product category, vendor, and this user as well as his/her friends (produced by the data mining unit); and (ii) compute the relevance ranking by multiplying the probability determined in (b)(i) with the bid value to give expected revenue that can be earned if a coupon is issued for that product.

(c) Rank the ads of (b) in decreasing order of their relevance ranking.

(d) The advertiser (telecom provider) can be paid by a vendor an amount as suggested by an auction scheme such as the second price auction scheme (the highest bidder wins, but the price paid is the second-highest bid). The amount will be paid only when the customer makes a purchase from the vendor and that is reported to the telecom provider. The advertisers will have incentive in doing so because this will boost the corresponding probability and hence will let them bid low amounts even for the same level of footfalls.

In other embodiments, the pricing could be flat pricing also where the telecom provider gets a fixed amount for each display. In this case the relevance score can be measured by the looking at tradeoffs between the current revenue gain versus expected future losses that will accrue because of this customer becoming too annoyed with this ad and hence not using this service in future or reducing the frequency of using this service.

Various other alternative embodiments to the auction system and the general system described in connection with FIGS. 4-10 are, of course possible. For example, in some embodiments, the loyalty card can be embedded into the mobile device (such as in the main chip of the device) itself.

In some embodiments, use of SMS to trigger the pull mechanism can be replaced with many other channels such as missed call, IVR, call center, Internet (Email/Browser), etc.

In some embodiments, a data mining based system is employed using which a customer can get help if they are not sure about what category ads to pull or if they are not clear about their shopping needs.

An advertiser may have a fixed budget for the mobile advertising and may want to create several different campaigns and want to assign the impression price or bid and the daily budget for all of them. In these embodiments, an ad portfolio management assistant is provided for the advertisers which will guide them through this process.

In some embodiments, a mobile search engine is provided where users can use a query word or phrase and the system will only pull ads relevant for the query word or phrase. Thus, a search engine will be a combination of the ad matching device described above and an information resources based search engine.

Thus, systems and methods have been provided that incorporate real time attributes of customers and also allow the advertisers to express various parameters about their campaign, which may vary in real time (e.g., discount amount, bids, budgets, etc.).

In some embodiments, information is used in the process of real-time matching by optimizing on interests of the three parties involved in the process—the advertiser, the customer and the telecom provider (or third party provider) which provides the service of supplying advertisements. In some embodiments, after the matching is completed, there is a process of real-time tracking of purchase footfalls triggered by the ads and, using this information back in the matching process, in the process ensuring fair-value co-creation. Various embodiments provide effective matching of customers to advertisements, while effectively using a telecom provider as the delivery channel. Any combination or sub-combination of features or steps described in connection with FIGS. 1-11 is contemplated.

In some embodiments, a vendor offers a solution to a telecom operator for providing a service to advertisers and customers of the telco. Advertisers benefit because of the flexible advertising campaigns possible for which they can track ROI, and customers benefit by ads being more relevant.

Embodiments of the invention can take the form of entirely hardware elements, entirely software elements or an combination containing both hardware and software elements. In a preferred embodiment, embodiments of the invention are implemented as software elements, which include but are not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description set out above describes particular embodiments only and is not intended to limit the invention, whose scope is determined solely by the claims set out below. As used here, singular forms “a”, “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In compliance with the patent statutes, the subject matter disclosed herein has been described in language more or less specific as to structural and methodical features. However, the scope of protection sought is to be limited only by the following claims, given their broadest possible interpretations. The claims are not to be limited by the specific features shown and described, as the description above only discloses example embodiments.

What is claimed is:

1. A method for marketing to mobile devices of users, the method comprising:
receiving marketing messages from vendors along with information identifying the locations of the vendors and information indicating when the respective marketing messages expire;
starting a USSD session with a user's mobile device in response to a request from the user;
providing a menu to the user's mobile device in the USSD session with which the user can view marketing messages; and
automatically flushing expired marketing messages;
wherein marketing messages are stored and managed by a telecom provider instead of being sent to a mobile device's in-box.

2. The method of claim 1 wherein the USSD session is started in response to at least one of an SMS and a missed call.

3. The method of claim 1 wherein the marketing messages comprise coupons and a user may clip coupons of interest to a personal folder stored at the telecom provider.

4. The method of claim 1 and further comprising, in response to receiving an SMS marketing message from a user, trapping and managing, at the telecom provider, future SMS marketing messages from the same vendor.

5. The method of claim 1 wherein, using the menu, the user is able to indicate at least one of favorite vendors and favorite product categories.

6. The method of claim 1 and further comprising, in response to a user indicating a desire to forward a marketing message to a friend's mobile device, trapping and managing the marketing message, at the telecom provider, and sending an SMS notification to the friend's mobile device.

7. The method of claim 1 wherein, using the menu, the user is able to specify a location and obtain marketing messages specific to that location.

8. The method of claim 1 wherein the marketing messages comprise coupons, the method further comprising redeeming a coupon in response to receiving a coupon number from a vendor.

9. A data processing system configured to execute the method of claim 1.

10. A system for marketing to mobile devices of users, in which a user of a mobile device can pull advertisements of advertisers on-demand from a telecom provider, the system comprising:
a pull mechanism, using which a user of a mobile device can express an interest in fetching an advertisement, the pull mechanism including telecom equipment configured to receive a communication from the mobile device;
a mechanism using which a user can indicate product categories of interest, using the mobile device;
a system configured to record information relating to purchases by the user; and
an advertisement matching system configured to match advertisements to customers based on a plurality of real time attributes including at least one real time attribute selected from the group consisting of location of the user and product categories of interest to the user, as well as based on parameters of the telecom provider and parameters of the advertisers.

11. The system of claim 10 wherein the pull mechanism is configured to receive an SMS from a user.

12. The system of claim 10 wherein the pull mechanism is configured to receive a missed call from a user.

13. The system of claim 10 and further configured to receive parameters specified by advertisers including at least one parameter selected from the group consisting of product description, product category, advertiser's location, and discount amount.

14. The system of claim 10 and further comprising a data mining system configured to examine characteristics of purchases made by the user.

15. The system of claim 10 and further configured to define advertiser marketing campaigns, and configured to receive advertising budget parameters specified by advertisers for respective marketing campaigns, including pay per impression fee rates.

16. The system of claim 10 and further configured to define advertiser marketing campaigns, and configured to receive advertising bid limits specified by advertisers for respective marketing campaigns, wherein ads are delivered in an auction system based at least in part on an advertiser's bid, and competing advertisers' bid amounts.

17. A method of marketing to mobile devices of users from a telecom operator, the method comprising:
receiving a telecom contact from a user of a mobile duevice, the contact indicating an interest in fetching an advertisement, and receiving product categories of interest to the user;
matching a user with at least one advertisement based on at least some of product categories of interest to the user and a location of interest to the user;
selecting at least one advertisement relevant to the user and based on at least one metric of interest to the advertiser as well based on at least one metric of interest to the telecom operator; and
delivering at least one advertisement to the mobile device.

18. The method of claim 17 and further comprising receiving advertisement campaign parameters from an advertiser, the parameters including at least product category and location parameters, and using the advertisement campaign parameters in the selecting.

19. The method of claim 17 and further comprising receiving advertisement campaign budget information from an advertiser, and using the budget information in the selecting.

20. The method of claim 17 and further comprising logging information about purchases by the user and performing data mining on the logged information to compute estimates of probability that sending a particular advertisement to a particular user will result in at least one of a footfall and a purchase by the user.
